(19) United States
(12) Patent Application Publication
(10) Pub. No.: US 2013/0156879 A1
(43) Pub. Date: Jun. 20, 2013

(54) PATTERN TRANSFER APPARATUSES AND METHODS FOR CONTROLLING THE SAME

(71) Applicant: SAMSUNG ELECTRONICS CO., LTD., Suwon-Si (KR)

(72) Inventors: Sung Hoon LEE, Seoul (KR); Young Tae CHO, Daejeon (KR)

(73) Assignee: SAMSUNG ELECTRONICS CO., LTD., Suwon-Si (KR)

(21) Appl. No.: 13/691,969

(22) Filed: Dec. 3, 2012

(30) Foreign Application Priority Data
Dec. 14, 2011 (KR) 10-2011-0134146

(51) Int. Cl. B29C 59/02

(52) U.S. Cl. CPC B29C 59/026
USPC 425/385

(57) ABSTRACT

A pattern transfer apparatus including a microscope having an ocular lens provided in a first housing, an objective lens provided in a second housing and a body tube connecting the ocular lens and the objective lens to each other, and a stamp coupled to an opening of the second housing and having a pattern to be transferred to a substrate may be provided. Checking of both defect position and transfer position of the substrate and transferring of the pattern can be performed concurrently through the microscope integrated with the stamp. Accordingly, the repetitive and continuous micro pattern transfer process can be more efficiently and rapidly performed, and the pattern can be more accurately and precisely transferred to the substrate.

### CROSS-REFERENCE TO RELATED APPLICATION

This application claims the benefit of Korean Patent Application No. 2011-0134146, filed on Dec. 14, 2011 in the Korean Intellectual Property Office, the disclosure of which is incorporated herein by reference in its entirety.

### BACKGROUND

1. Field

Example embodiments of the present inventive concepts relate to transfer apparatuses to transfer a pattern to a substrate and/or methods for controlling the same.

2. Description of the Related Art

In general, a photolithography process to form a micro pattern using light is applied to micro sensors, photonic crystal optical devices, micro mechatronic devices, display devices, displays such as field emission displays (FEDs), organic light-emitting diodes (OLEDs) and plasma display panels (PDPs), solar cells and semiconductors.

However, whenever a pattern is formed by using a photolithography process, exposure, development, etching and cleaning processes also should be performed, and this requires a relatively long processing time. Further, because the photolithography process should be repeatedly performed, productivity of the photolithography process is relatively low.

According to demands for larger LCD substrates, micro patterns and higher price competitiveness, innovative lithography processes replacing the existing photolithography process have been a great focus of attention and research.

Recently, an imprint or roll-print lithography process has been developed. Compared with the photolithography process, the imprint or roll-print lithography process is simpler, and the equipment for the process is also simpler because the exposure process is not needed. According to the simplicity of the process, the imprint or roll-print lithography process can be performed in a remarkably reduced space of a clean room, and can have a higher price competitiveness by achieving micro patterns with lower-cost equipment.

The imprint lithography process is a process of imprinting a micro pattern onto a substrate using a stamp imprinted with the micro pattern. The roll-print lithography process is a process of imprinting a micro pattern onto a substrate using a roll imprinted with the micro pattern or imprinting a micro pattern to a roll using a substrate imprinted with the micro pattern. For example, the substrate or the roll imprinted with the micro pattern is a kind of stamp.

However, the imprint or roll-print lithography process requires alignment with the previously-printed micro pattern on the substrate during the repetitive and continuous transfer of the micro pattern to the substrate, and also requires alignment using alignment marks or laser sensors during the transfer of the succeeding micro pattern.

Also, the imprint or roll-print lithography process requires checking for defects of the substrate using a scanning electron microscope (SEM) or a transmission electron microscope (TEM) during transfer.

Because the checking of the defect position of the substrate using the microscope is performed independently from the transfer of the micro pattern of the stamp, an error or a difference between the defect position of the substrate checked by the microscope and the transfer position of the micro pattern of the stamp is encountered, thereby increasing the process time for patterning.

### SUMMARY

An aspect of the present inventive concepts provides a transfer apparatus equipped with a microscope integrated with a stamp and/or a method for controlling the same in which substrate defect checking through the microscope integrated with the stamp and pattern transfer using the stamp can be performed at the same time.

Some aspect of the present inventive concepts provides a transfer apparatus and/or a method for controlling the same in which the pattern is transferred to the substrate using the stamp while a transfer position of the substrate is being checked through the microscope.

Other aspect of the present inventive concepts provides a transfer apparatus equipped with a stamp, which is removably coupled to the microscope, and/or a method for controlling the same.

Still other aspects of the inventive concepts will be set forth in part in the description which follows and, in part, will be obvious from the description, or may be learned by practice of the inventive concepts.

According to an example embodiment, a pattern transfer apparatus includes a microscope including an ocular lens provided in a first housing, an objective lens provided in a second housing, and a body tube connecting the ocular lens and the objective lens to each other, and a stamp coupled to an opening of the second housing, the stamp having a pattern to be transferred to a substrate.

The stamp may be removably coupled to the opening of the second housing or may be attached to the opening of the second housing.

The stamp may be made of a transparent elastomer.

The pattern transfer apparatus may further include a moving assembly configured to move the microscope, and a control unit including an image acquisition part configured to acquire an image of the substrate through the ocular lens and the objective lens, and a controller configured to check at least one of a transfer position and a defect position based on the image of the substrate and configured to control an operation of the moving assembly such that the pattern is transferred to at least one of the transfer position and the defect position.

The objective lens and the second housing may be provided in plural, respectively, and the microscope may further include a rotary plate configured to change positions of the plurality of objective lenses.

The plurality of objective lenses may have different magnifications from each other, and the stamp having a micro pattern may be coupled to the objective lens, which has a magnification sufficient to observe the micro pattern.

According to an example embodiment, a control method for a pattern transfer apparatus including a first stage on which a substrate is located, a second stage onto which a functional material is spread and a microscope moving between the first stage and the second stage, includes moving the microscope integrated with a stamp to the second stage, controlling contact between the functional material and the stamp such that the functional material is spread onto a pattern of the stamp, moving the microscope integrated with the stamp to the first stage after completing the spreading of the functional material onto the pattern of the stamp, checking the substrate through the microscope integrated with the stamp, controlling contact between the microscope integrated with the stamp and the substrate so that the pattern of the stamp is transferred to the substrate, and moving the microscope integrated with the stamp away from the substrate after completing the transferring of the pattern to the substrate.

The controlling contact between the microscope with the stamp and the substrate may include controlling contact pressure of the microscope with the stamp to apply a desired (or alternatively, preset) pressure to the substrate.

The checking the substrate may include acquiring an image of the substrate through the microscope integrated with the stamp, and checking a defect position of the substrate based on the image.

The transferring the pattern of the stamp to the substrate may include transferring a defect position marking pattern to an area around the defect position.

The checking the substrate may include acquiring an image of the substrate through the microscope integrated with the stamp, checking a previously-formed pattern based on the image, and checking a transfer position of the substrate based on the previously-formed pattern.

The control method may further include selecting an objective lens of a plurality of objective lenses based on the previously-formed pattern, each of the plurality of objective lens having a stamp with a pattern to be transferred to the substrate, and controlling rotation of a rotary plate to which the plurality of objective lenses are mounted such that the selected objective lens is positioned opposite the first stage.

The control method may further include determining whether the transferring of the pattern is successful by comparing the pattern transferred to the substrate and a target (or alternatively, desired or preset) pattern.

The control method may further include selecting an objective lens of a plurality of objective lenses through an input part, and controlling rotation of a rotary plate to which the plurality of objective lenses are mounted such that the selected objective lens is positioned opposite the first stage.

According to an example embodiment, a pattern transfer apparatus includes a first stage configured to support a substrate, and a transfer unit. The transfer unit includes an ocular lens, at least one objective lens coupled to the ocular lens through a connection medium, and a stamp removably coupled to the objective lens. The at least one objective lens is configured to face the first stage and the ocular lens is configured to magnify an image magnified by the objective lens. The stamp includes a background part embossed or engraved by a pattern.

The stamp may be made of a transparent elastomer such that the substrate is observable through the at least one objective lens.

The connection structure may be a body tube The body tube may provide physical and/or mechanical connection between the ocular lens and the at least one objective lens and maintain a distance therebetween.

The at least one objective lens may be a plurality of objective lenses having different magnification levels.

The pattern transfer apparatus may further include a rotary plate, the plurality of objective lenses are mounted thereon and configured to rotate.

The background part of the stamp may include a body, an accommodating part enclosed by the body, the accommodating part configured to store a functional material, and a discharge part covered by the pattern, the discharge part configured to discharge the functional material through the pattern.

The pattern transfer apparatus may further include a dispenser adjacent to the transfer unit and a second stage near the first stage. The dispenser may be configured to discharge a functional material through outlet ports thereof, and the second stage having a container may be configured to receive the functional material from the dispenser.

As described above, the checking of both defect position and transfer position of the substrate and the pattern transfer may be performed at the same time through the microscope integrated with the stamp. Accordingly, the repetitive and continuous micro pattern transfer process may be performed more efficiently and rapidly, and the pattern may be transferred to the substrate more accurately and precisely.

Also, because the stamp can be removed from the microscope, various patterns can be transferred through a single microscope, thereby improving economic feasibility.

Also, because the pattern size of the stamp coupled to the microscope can be adjusted according to the magnification of the objective lens of the microscope, pattern transfer may be facilitated.

Also, because the defect position of the substrate can be marked immediately upon detecting the defect, a user may analyze the cause of the defect with relative ease.

### BRIEF DESCRIPTION OF THE DRAWINGS

These and/or other aspects of the inventive concepts will become apparent and more readily appreciated from the following description of example embodiments, taken in conjunction with the accompanying drawings of which:

FIG. 1 is a perspective view showing a pattern transfer apparatus according to an example embodiment;

FIG. 2 is a perspective view showing a microscope integrated with a stamp of the pattern transfer apparatus according to the example embodiment;

FIGS. 3A through 3D illustrate example stamps provided at a transfer unit of the pattern transfer apparatus according to the example embodiment;

FIGS. 4A-4B and 5 illustrate example objective lenses and stamps of transfer units of the transfer apparatus according to example embodiments;

FIG. 6 illustrates another example microscope of the transfer apparatus according to an example embodiment;

FIG. 7 illustrates another example stamp of the transfer unit according to an example embodiment;

FIG. 8 is a control block diagram of the transfer apparatus according to an example embodiment;

FIGS. 9A-9B illustrate example pattern transfers in the transfer apparatus according to an example embodiment; and

FIGS. 10A through 10E illustrate a process flow of a method for controlling the transfer apparatus according to an example embodiment.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments will now be described more fully with reference to the accompanying drawings. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements throughout, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

A transfer apparatus according to an example embodiment of the present inventive concepts is a micro pattern transfer apparatus equipped with an optical microscope integrated with a stamp, in which checking of a substrate, to which a micro pattern is transferred, through the optical microscope and micro pattern transfer to the substrate using the stamp can be performed at the same time.

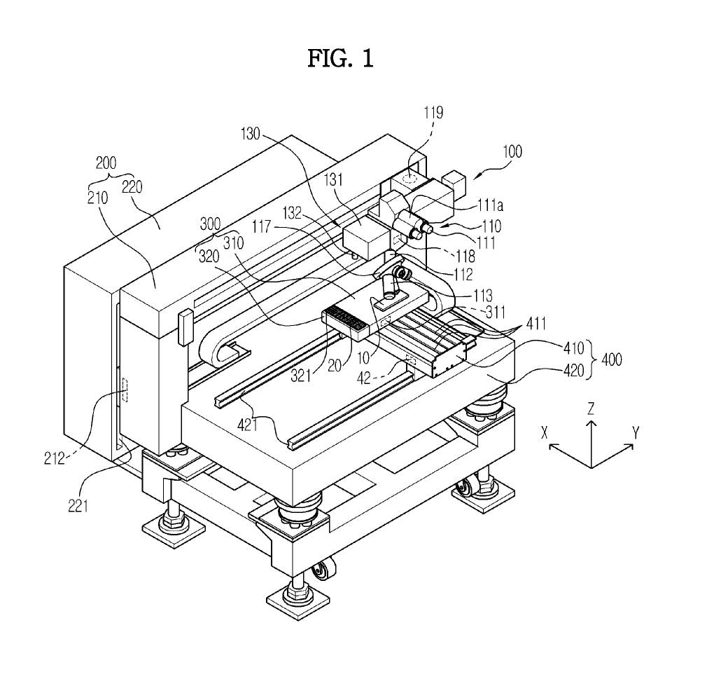

FIG. 1 is a perspective view showing the pattern transfer apparatus according to an example embodiment. The pattern transfer apparatus includes a transfer unit 100, a first support unit 200, a stage unit 300, a second support unit 400 and a base unit 500.

The transfer unit 100 is configured to transfer a pattern of a stamp to a substrate 10 by checking a defect position and a transfer position on the whole surface of the substrate 10, spreading a functional material 20 contained in a container onto the stamp, and contacting the stamp on which the functional material is spread to the substrate 10. For example, the pattern may be a micro pattern.

Referring to FIG. 1, the transfer unit 100 may be movable along the axis of the first support unit 200.

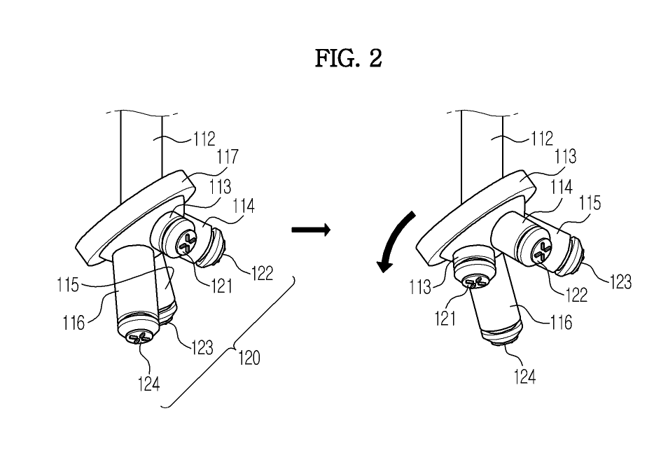

The transfer unit 100 may include a microscope 110, stamps 120 (121, 122, 123, and 124) and a dispenser 130, which may be integrated with each other. For example, the dispenser 130 may be removable. The transfer unit 100 will be described later in more detail with reference to FIGS. 2 through 5.

The first support unit 200 may be configured to support the transfer unit 100.

The first support unit 200 may serve as a movement assembly to move the transfer unit 100. The first support unit 200 may include a first support block 210, a second support block 220, a first motor 119 and a second motor 212.

The transfer unit 100 may be mounted to the first support block 210 so as to move left and right in a Y-axis direction. The first support block 210 may be mounted to the second support block 220 so as to move up and down in a Z-axis direction.

The first support block 210 may be provided with a first guide member 211 to guide the left-right movement of the transfer unit 100, and the second support block 220 may be provided with a second guide member 221 to guide the up-down movement of the first support block 210.

The transfer unit 100 may move up and down by the movement of the first support block 210 along the second guide member 221 of the second support block 220.

Describing an example moving structure of the transfer unit 100, the first guide member 211 of the first support block 210 may be engaged with the transfer unit 100 using a rack and pinion, and the transfer unit 100 may move along the rack (not shown) of the first guide member 211 by the operation of the first motor 119 provided at the transfer unit 100.

Also, the second guide member 221 of the second support block 220 may be engaged with the first support block 210 using a rack and pinion, and the first support block 210 may move along the rack (not shown) of the second guide member 221 by the operation of the second motor 212 provided at the first support block 210.

The stage unit 300 may include a first stage 310 on which the substrate 10 to be transferred with a pattern is to be located, and a second stage 320 on which a container 321 containing a functional material 20 is located.

The stage unit 300 may be movable forward and backward in the X-axis direction and left and right in the Y-axis direction along the second support unit 400.

The first stage 310 and the second stage 320 may be removable from the transfer apparatus.

The second stage 320 may be made of glass or metal.

The functional material 20 may be any one of an ink, metal thin film, high molecular substance, insulating film material and polymer. The functional material 20 may be decided based on the pattern to be transferred to the substrate.

The second support unit 400 may include a third support block 410 to which the stage unit 300 may be movably mounted, and a fourth support block 420 to which the third support block 410 may be movably mounted.

The third support block 410 may be provided with a third guide member 411 to guide the forward-backward movement of the stage unit 300, and the fourth support block 420 may be provided with a fourth guide member 421 to guide the left-right movement of the third support block 410.

The stage unit 300 may move left and right by the movement of the third support block 410 along the fourth guide member 421 of the fourth support block 420.

The third guide member 411 and the fourth guide member 421 may be provided in plural.

Describing an example moving structure of the stage unit 300, the third guide member 411 of the third support block 410 may be engaged with the stage unit 300 using a rack and pinion (not shown), and the stage unit 300 may move along the rack (not shown) of the third guide member 411 by the operation of a third motor 311 provided at the stage unit 300.

Also, the fourth guide member 421 of the fourth support block 420 may be engaged with the third support block 410 using a rack and pinion (not shown), and the third support block 410 may move along the rack (not shown) of the fourth guide member 421 by the operation of a fourth motor 412 provided at the third support block 410.

When transfer of the pattern of the stamps 120 is completed, the stage unit 300 may move outwardly so that the substrate to which the pattern has been transferred can be easily withdrawn.

The stage unit 300 may also move forward, backward, left and right by manual user operation.

The base unit 500 supports the transfer unit 100, the first support unit 200, the stage unit 300 and the second support unit 400, which are disposed thereon.

Hereinafter, the transfer unit 100 will be explained in more detail with reference to FIGS. 1 through 5.

As shown in FIGS. 1 to 2, the transfer unit 100 includes the microscope 110, the stamps 120 and the dispenser 130.

The previously-formed pattern, defect position and transfer position on the whole surface of the substrate 10 may be checked using the microscope 110. The microscope 110 may be, for example, an optical microscope.

The microscope 110 may include an ocular lens 111, a body tube 112, a plurality of objective lenses 113, 114, 115 and 116, a rotary plate 117, a fifth motor 118 and the above-mentioned first motor 119. An explanation of the above-mentioned first motor 119 is omitted.

The ocular lens 111 is the one a user looks through, which may include a first housing 111a and a plurality of lenses (not shown) provided in the first housing 111a. The ocular lens 111 may function to magnify an image magnified by the objective lens and determine the observation range.

Accordingly, a user can observe the state of the substrate 10 through the ocular lens 111.

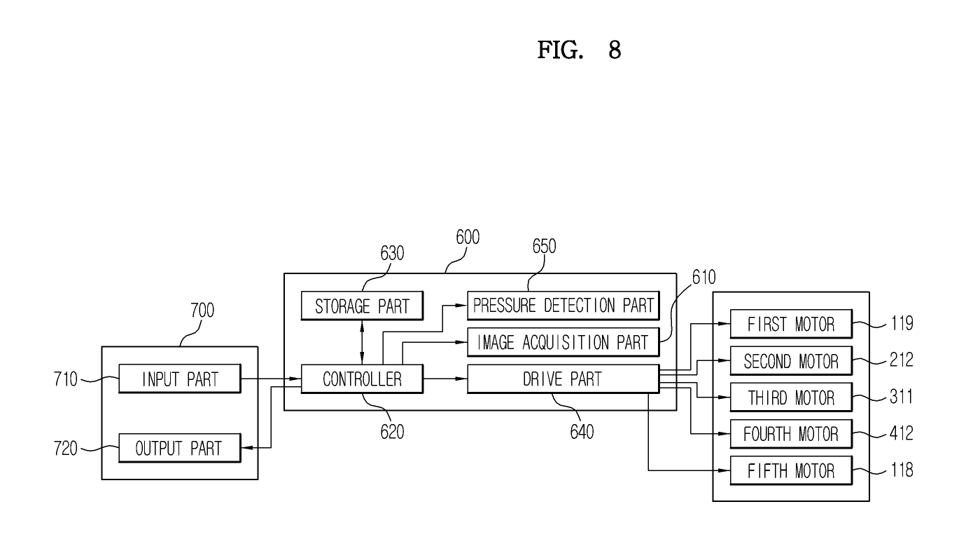

The ocular lens 111 may be provided with an image acquisition part 610 (shown in FIG. 8). Therefore, a user may observe the state of the substrate 10 using the image acquired through the image acquisition part 610.

The body tube 112 may be formed between the ocular lens 111 and the plurality of objective lenses 113, 114, 115 and 116. The body tube 112 may serve to keep a distance between the ocular lens 111 and the plurality of objective lenses 113, 114, 115 and 116 constant.

The microscope 110 may be constituted to have only a single objective lens.

The plurality of objective lenses 113, 114, 115 and 116 may be used to form an image of the substrate 10, and may include a plurality of lenses to form a magnified image of the substrate 10.

A user may observe the substrate 10 at a position spaced apart from the substrate 10 through one of the plurality of objective lenses.

As shown in FIG. 2, the plurality of objective lenses 113, 114, 115 and 116 may be respectively coupled with stamps 121, 122, 123 and 124. The stamps may be coupled to at least one of the plurality of objective lenses 113, 114, 115 and 116.

The plurality of objective lenses 113, 114, 115 and 116 may have different lengths from each other, and accordingly may have different magnifications from each other. For example, the first objective lens 113 may have a magnification level of 4×, the second objective lens 114 may have a magnification level of 10×, the third objective lens 115 may have a magnification level of 40×, and the fourth objective lens 116 may have a magnification level of 100×.

The plurality of objective lenses 113, 114, 115 and 116 may be attached to the rotary plate 117. As the rotary plate 117 rotates, the plurality of objective lenses 113, 114, 115 and 116 simultaneously rotate about the axis of the rotary plate 117. Accordingly, it is determined which objective lens is to be used to form a magnified image of the substrate 10.

The rotary plate 117 may rotate by a manual operation or by an automatic rotation using the fifth motor 118.

The patterns of the stamps coupled to the plurality of objective lenses 113, 114, 115 and 116 may be all the same, partially the same or completely different from each other in shape and size.

The stamp having a micro pattern may be coupled to the objective lens having a higher magnification, so that the smaller micro pattern can be observed at the higher magnification. In other words, the objective lens has a magnification sufficient to observe the micro pattern. Accordingly, the substrate can be more easily and more accurately observed.

As described above, the size of the micro pattern formed at the stamp may be determined according to the magnification of the corresponding objective lens coupled with the stamp. As a result, the micro pattern to be subsequently transferred to the substrate may have similarity and/or suitability to the size of a pattern on the substrate or the previously-formed micro pattern.

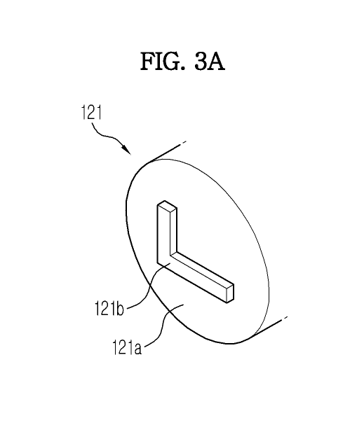

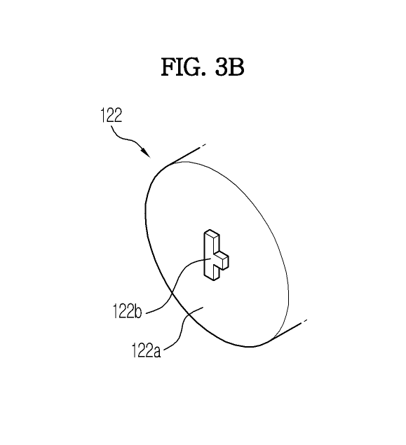

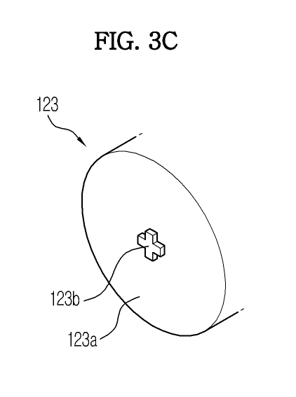

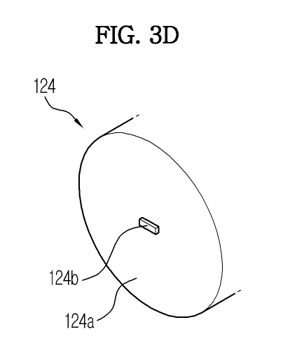

As shown in FIG. 3, the first objective lens 113 having the lowest magnification may be coupled with the first stamp 121 having the largest pattern. The second objective lens 114 having the third highest magnification may be coupled with the second stamp 122 having the third smallest pattern. The third objective lens 115 having the second highest magnification may be coupled with the third stamp 123 having the second smallest pattern. The fourth objective lens 116 having the highest magnification may be coupled with the fourth stamp 124 having the smallest pattern.

Also, as shown in FIGS. 3A through 3D, each of the patterns of the stamps coupled to the objective lenses may have different shapes, respectively. The stamp having the pattern to be transferred to the substrate may be first checked, and then the objective lens coupled with the corresponding stamp moves to a position opposite to the substrate, thereby transferring the proper pattern to the substrate.

The stamp may be removably coupled to the objective lens or may be attached to the objective lens.

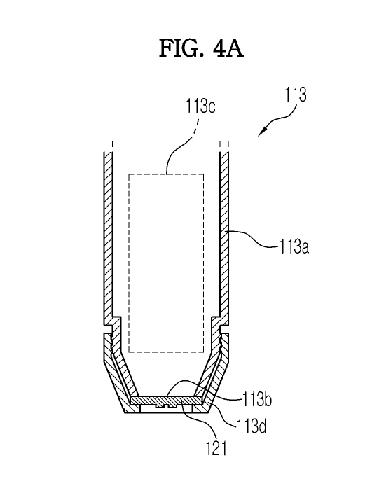

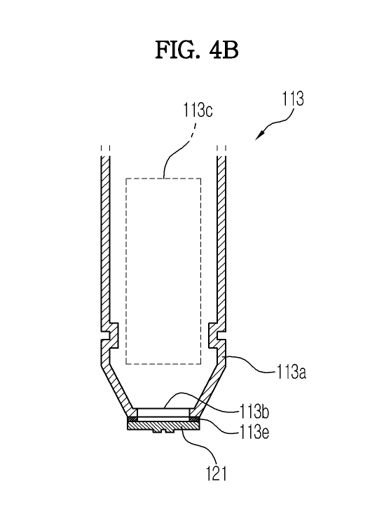

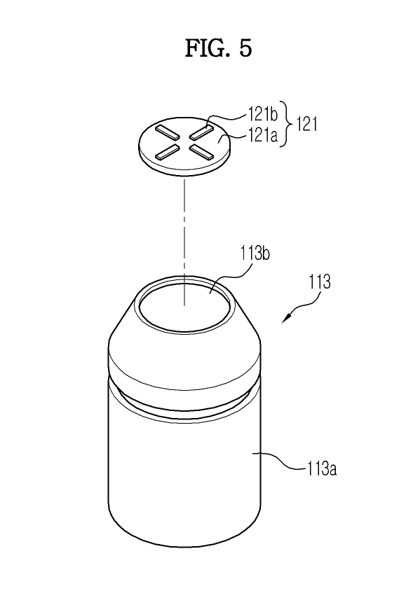

Hereinafter, a coupled structure of the objective lens and the stamp will be explained with reference to FIGS. 4 and 5. The coupling structure of the first objective lens 113 and the first stamp 121 will be representatively explained.

As shown in FIG. 4A, the first objective lens 113 may include a second housing 113a, an opening 113b formed at the second housing 113a, a lens part 113c disposed in the second housing 113a, and a cover 113d.

The first stamp 121 is positioned between the opening 113b of the second housing 113a and the cover 113d. The first stamp 121 is removably coupled to the first objective lens 113 by the cover 113d.

As shown in FIG. 4B, the first objective lens 113 may include a second housing 113a, an opening 113b formed at the second housing 113a, a lens part 113c disposed in the second housing 113a, and an adhesive part 113e provided around the opening 113b of the second housing 113a.

The first stamp 121 may be attached to the second housing 113a of the first objective lens 113 by the adhesive part 113e.

Also, as shown in FIG. 5, the first stamp 121 may be coupled to the first objective lens 113 including the second housing 113a and the opening 113b in such a manner that the first stamp 121 is tightly inserted into the opening 113b by applying physical pressure to the first stamp 121.

The patterns to be transferred to the substrate 10 may be formed at the stamps 120 coupled to at least one of the plurality of objective lenses.

After spreading the functional material 20 contained in the container 321 onto the stamp, the patterns of the stamps 120 may be transferred to the substrate 10 by contact between the stamps 120 and the substrate 10.

The patterns of the stamps may be embossed or engraved.

Hereinafter, the stamps 121, 122, 123 and 124 formed with the embossed patterns will be exemplarily explained.

As shown in FIG. 3A, the first stamp 121 may include a background part 121a and an embossed part 121b protruding from the background part 121a to form the pattern to be transferred. Similarly, as shown in FIG. 3B, the second stamp 122 may include a background part 122a and an embossed part 122b protruding from the background part 122a to form the pattern to be transferred.

As shown in FIG. 3C, the third stamp 123 may include a background part 123a and an embossed part 123b protruding from the background part 123a to form the pattern to be transferred, and, as shown in FIG. 3D, the fourth stamp 124 may include a background part 124a and an embossed part 124b protruding from the background part 124a to form the pattern to be transferred.

The stamps 120 may be made of an elastomer or a highly polymerized compound having the elastic properties that can be extended to several times its original length by external force pulling the same and restored to the original length when released from the external force. The elastomer may be a transparent material.

Accordingly, even when the stamp is coupled to the objective lens, a user may observe the substrate through the objective lens.

The dispenser 130 may be disposed adjacent to the transfer unit 100. The dispenser 130 may receive the functional material 20, for example, in liquid form, from the external source and stores the same. When the transfer command is input, the dispenser 130 discharges the functional material 20 to the container 321.

Such a dispenser 130 may include a housing 131 to receive the functional material 20 and store the same, an inlet port through which the functional material 20 is introduced from the external source, and an outlet port 132 through which the functional material 20 is discharged from the housing 131.

The dispenser 130 may further include a blade (not shown) to keep a thickness of the functional material 20 discharged to the container 321 constant.

The blade may be configured as a thin plastic or metal blade or a cylindrical bar. The blade may control the contact force and/or speed to control the thickness of the functional material 20, thereby achieving the desired pattern thickness on the substrate 10.

The dispenser 130 may be removable from the transfer unit 100.

The dispenser 130 may be disposed at a position opposite to the container 321, or a user may directly put the functional material 20 in the container 321 without the dispenser 130.

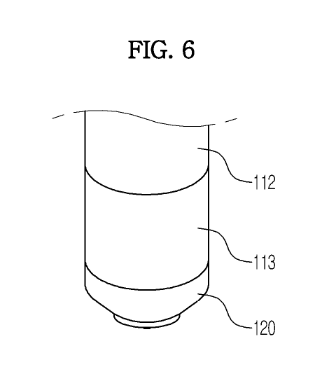

As shown in FIG. 6, the microscope 110 may be structured to have a single objective lens 113.

In other words, the single objective lens 113 may be physically and mechanically connected to the ocular lens 111 through the body tube 112.

In such a structure, the single stamp 120 may be removably coupled to the single objective lens 113.

The transfer apparatus may be constituted such that the transfer unit 100 includes only the microscope 110 and the stamp 120, and the functional material 20 is contained in the stamp 120.

The structure by which the functional material 20 is contained in the stamp 120 and discharged from the stamp 120 according to the pattern can be embodied in various ways.

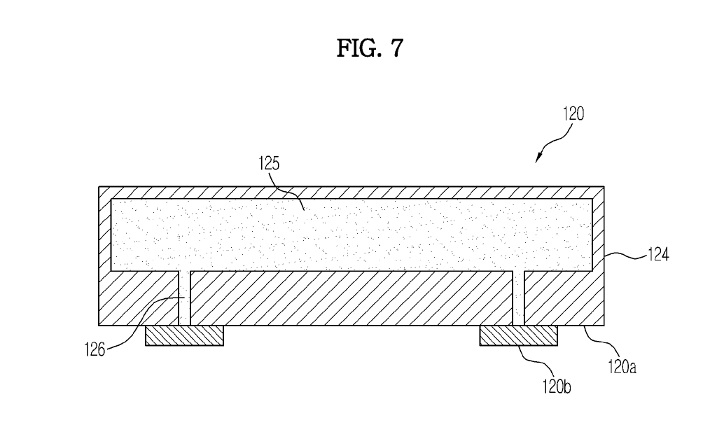

For example, as shown in FIG. 7, the stamp 120 may include a body 124, an accommodating part 125 formed in the body 124, and a discharge part 126 through which the functional material 20 in the accommodating part 125 is discharged.

The stamp 120 may further include a background part 120a and an embossed part 120b protruding from the background part 120a. The functional material 20 in the accommodating part 125 may be discharged through the embossed part 120b, and thus the pattern corresponding to the embossed part 120b may be transferred to the substrate 10.

FIG. 8 is a control block diagram of the transfer apparatus according to an example embodiment. As shown in the drawing, the control unit 600 may include an image acquisition part 610, a controller 620, a storage part 630, a drive part 640 and a pressure detection part 650.

The control unit 600 may receive a transfer command through an external user interface 700, and transmit a transfer result such that the substrate checking and pattern transfer result is output.

The image acquisition part 610 may acquire the image of the substrate 10 observed through the ocular lens 111.

The controller 620 may check the state of the substrate 10 based on the image of the substrate 10 observed through the transfer unit 100, which may be, for example, a microscope integrated with the stamp. If the checked state of the substrate 10 is normal, the controller 620 outputs the same to the external user interface 700.

Also, when the functional material 20 is to spread onto the stamp to transfer the pattern to the normal substrate 10, the controller 620 controls the left-right movement of the transfer unit 100 so that the transfer unit 100 may be positioned opposite the second stage 320. If the transfer unit 100 is positioned opposite to the second stage 320, the controller 620 may control the up-down movement of the transfer unit 100 so that the stamp 120 of the transfer unit 100 may come into contact with the functional material 20 on the second stage 320.

While the stamp 120 contacts the functional material 20 of the second stage 320, the controller 620 may control the contact time and contact pressure.

Also, if the functional material 20 is spread onto the stamp 120 of the transfer unit 100 in the process of transferring the pattern to the normal substrate 10, the controller 620 may control the left-right movement of the transfer unit 100 so that the transfer unit 100 is positioned opposite the first stage 310. If the transfer unit 100 is positioned opposite the first stage 310, the controller 620 controls the up-down movement of the transfer unit 100 so that the stamp 120 of the transfer unit 100 may come into contact with the substrate 10 on the first stage 310.

While controlling the contact between the transfer unit 100 and the substrate 10 for pattern transfer, the controller 620 may control the contact pressure between the transfer unit 100 and the substrate 10 based on the pressure detected by the pressure detection part 650 so that a desired (or alternatively, preset) pressure is applied to the substrate 10.

If the functional material on the pattern of the stamp 120 of the transfer unit 100 is completely transferred to the substrate 10 of the first stage 310, the controller 620 may control the up-down movement of the transfer unit 100 so that the transfer unit 100 moves away from the substrate 10.

The controller 620 may determine whether pattern transfer is successful by comparing the pattern transferred to the substrate 10 and the desired (or alternatively, preset or target) pattern, and transmits the determination result to an output part 720.

If it is determined that the substrate 10 is abnormal, that is, that the substrate 10 has a defect, the controller 620 may check the defect position and transmit the checked defect position to the output part 720.

Also, if it is determined that the substrate 10 is abnormal, that is, that the substrate 10 has a defect, the controller 620 may check the defect position and transfer the defect position marking pattern to the checked defect position, thereby enabling a user to determine the cause of the defect.

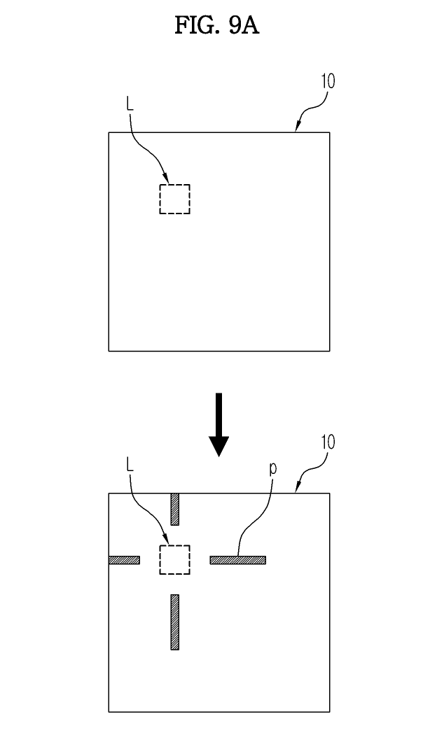

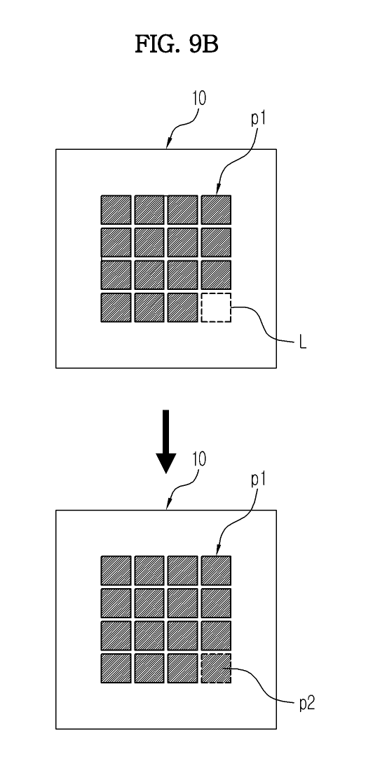

In more detail, as shown in FIG. 9A, if the defect of the substrate 10 is detected, the controller 620 may check the defect position L, control the up-down movement of the objective lens above the checked defect position L, and transfer the defect position marking pattern of the transfer unit 100 to the defect position L. Accordingly, the pattern p of the stamp may be transferred to the area around the defect position L.

When the secondary pattern is subsequently transferred to the substrate to which the first pattern has been transferred, the controller 620 may check the transfer position and transfers the secondary pattern to the checked transfer position.

In more detail, as shown in FIG. 9B, if the controller 620 may receive a command from an input part 710 to transfer the additional pattern to the substrate 10 having the previously-formed pattern p1, the controller 620 may check the previously-formed pattern p1 based on the image of the substrate 10, and check the transfer position L for the pattern to be subsequently transferred based on the checked pattern p1. Then, the controller 620 may control the direction of the objective lens so that the pattern of the stamp is positioned opposite the checked transfer position L. Finally, if the transfer position of the pattern of the stamp is identical to the checked transfer position L, the controller 620 may control the transfer of the pattern of the transfer unit 100 to transfer the pattern p2 of the stamp to the checked transfer position.

Here, controlling the direction of the objective lens may be performed using a motor (not shown).

As a result, in the repetitive and continuous process of transferring the micro pattern to the substrate, the additional micro pattern transfer can be achieved while maintaining alignment with the previously-formed micro pattern on the substrate.

When controlling the movement of the transfer unit 100, the controller 620 controls the operation of at least one of the first motor and the second motor. Also, when controlling the movement of the stage unit 300 before and after pattern transfer, the controller 620 controls the operation of at least one of the third motor and the fourth motor.

If one of the plurality of objective lenses 113, 114, 115 and 116 is selected through the input part 710, the controller 620 may control the automatic rotation of the rotary plate 117 so that the selected objective lens faces the first stage 310.

Further, the controller 620 may check the pattern previously-formed on the substrate 10 and determine which objective lens has the stamp formed with the pattern to be subsequently transferred based on the checked previously-formed pattern. Then, the controller 620 may control the automatic rotation of the rotary plate 117 so that the determined objective lens faces the first stage 310.

The storage part 630 may store the image information of the normal substrate 10, the pressure applied to the substrate 10 during the pattern transfer, the information regarding the successfully transferred pattern, the information regarding the previously-formed pattern on the substrate 10, and the information regarding the transfer position corresponding to the information regarding the previously-formed pattern.

The storage part 630 may also store the information regarding the objective lens having the stamp corresponding to the information regarding the previously-formed pattern on the substrate 10, and the rotation angle of the rotary plate corresponding to the information regarding the objective lens.

The controller 620 may control such that the drive part 640 drives the first and second motors 119 and 212 to move the transfer unit 100, drives the third and fourth motors 311 and 412 to move the stage unit 300 (310 and 320), and drives the fifth motor 118 to rotate the rotary plate 117.

The pressure detection part 650 may be, for instance, a force sensor or a pressure sensor. When the stamps 120 (121, 122, 123 and 124) contact the substrate 10 to transfer the functional material 20 from the pattern of the stamps to the substrate 10, the pressure detection part 650 may detect the pressure applied to the substrate 10.

The pressure detection part 650 may be mounted to the first stage 310.

Due to the operation of the pressure detection part 650, deformation of the stamps 120 may be minimized and transfer of the micro pattern may be more precisely achieved.

The pressure detection part 650 may also be mounted to the second stage 320 so that the regular amount of functional material is spread onto the stamps 120.

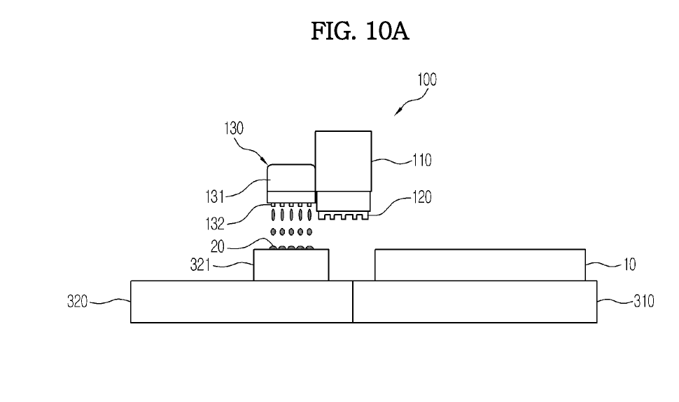

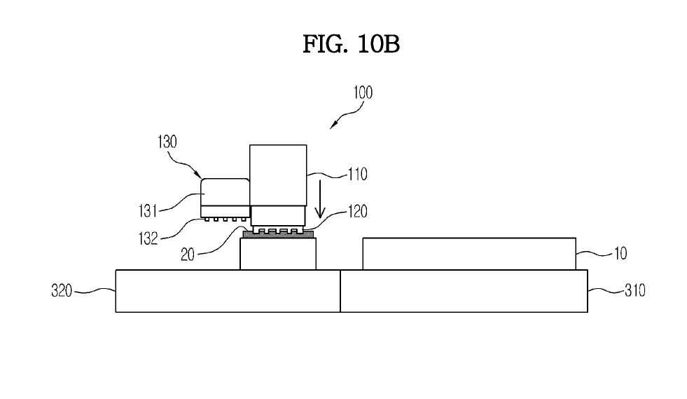

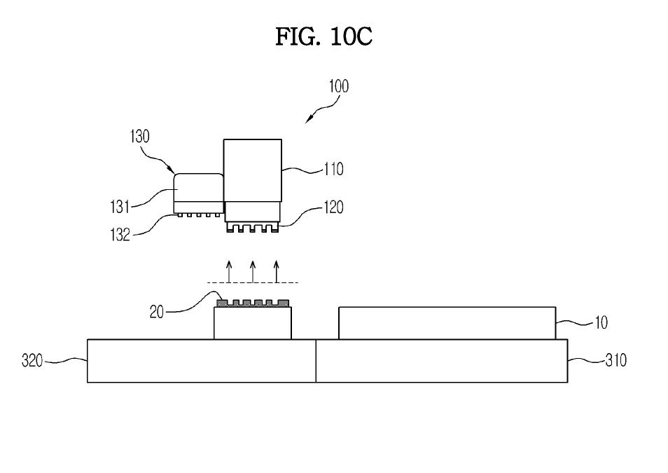

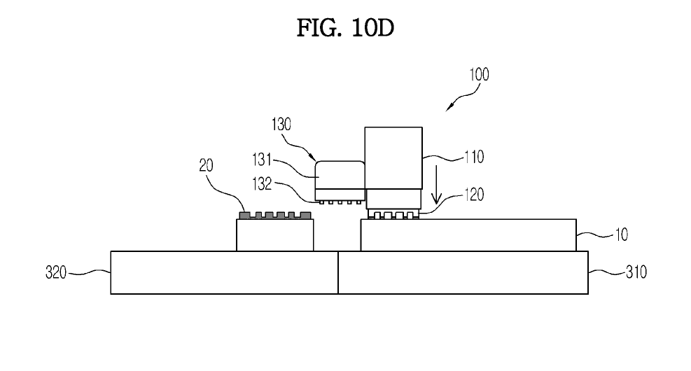

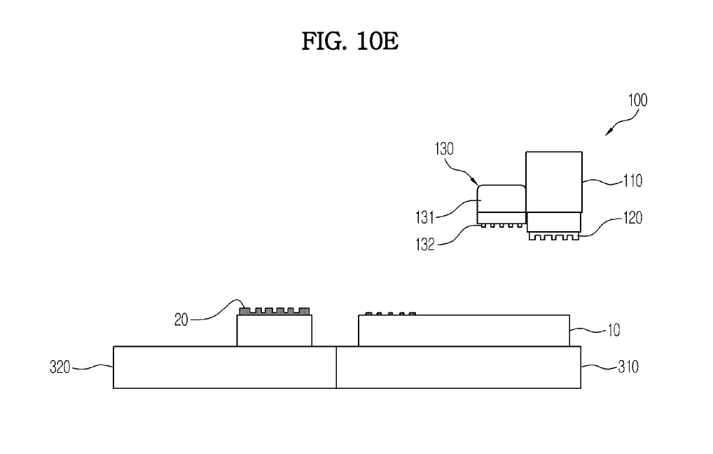

FIGS. 10A through 10E illustrate a process flow of a method for controlling the transfer apparatus according to an example embodiment.

If a command to transfer the pattern to the substrate is input through the input part 710, the control unit 600 may move the second support unit 400 forward, backward, left and right so that the stage unit 300 on which the substrate 10 is located is positioned below the transfer unit 100 mounted to the first support unit 200.

Next, the control unit 600 may acquire the image of the substrate 10 through the transfer unit 100, for example, the microscope integrated with the stamp, process the acquired image of the substrate 10, and check the position of the substrate 10 based on the processed image.

At this time, if the position of the substrate 10 is different from the target (or alternatively, desired or preset) position, the control unit 600 may output the information regarding the position deviation of the substrate.

If checking of the substrate position is completed, the control unit 600 may analyze the image of the substrate 10 and determine whether the substrate 10 is normal or not.

In other words, the control unit 600 may determine whether the substrate 10 has a defect due to, for example, nano/micro particles. If it is determined that the substrate 10 has a defect, the control unit 600 may output the same to the output part 720. Also, the control unit 600 may output the defect position to the output part 720, and control the forward-backward and left-right movement of the stage unit 300 so that the substrate 10 can be withdrawn.

In this process, a user may directly determine whether the substrate has a defect or not, and may input a pattern transfer command according to the determination result.

If it is determined that the substrate 10 is normal, the control unit 600 may move the transfer unit 100 toward the second stage 320 mounted with the container 321.

In this process, the control unit 600 may check the pattern transfer position, and may control the movement of the transfer unit 100 so that the pattern is transferred to the checked transfer position.

Next, as shown in FIG. 10A, the transfer unit 100 may discharge the functional material 20 to the container 321 of the second stage 320 through the outlet port 132 of the dispenser 130 for a certain length of time.

At this time, the thickness of the functional material 20 may be kept constant using the blade.

Next, as shown in FIG. 10B, if discharging of the functional material 20 is completed, the control unit 600 may control the up-down movement of the transfer unit 100 so that the transfer unit 100 comes into contact with the functional material 20 on the second stage 320.

At this time, contact between the stamps 120 of the transfer unit 100 and the functional material 20 may be controlled using at least one of the desired (or alternatively, target or preset) time or the desired (or alternatively, preset) pressure.

Then, as shown in FIG. 10C, the functional material 20 may be spread onto the transfer unit 100. In more detail, the functional material 20 may be spread only onto the embossed part of the pattern formed at the stamps 120 of the transfer unit 100.

The functional material 20 spread onto the embossed part of the stamps 120 may be naturally or forcibly dried for a certain length of time.

If the functional material 20 is completely spread onto the stamps 120 of the transfer unit 100, the control unit 600 may control the up-down and left-right movement of the transfer unit 100 so that the transfer unit 100 moves toward the first stage 310.

Next, as shown in FIG. 10D, the control unit 600 may control the up-down movement of the transfer unit 100 so that the stamps 120 of the transfer unit 100 come into contact with the substrate 10.

The control unit 600 may detect the pressure applied to the substrate 10, and compare the detected pressure with the preset pressure, thereby controlling the pressure applied to the substrate 10 to be below the desired (or alternatively, preset) pressure.

If the desired (or alternatively, target or preset) time passes, the control unit 600 may control the up-down movement of the transfer unit 100 so that the transfer unit 100 moves away from the substrate 10. As a result, the pattern of the stamps 120 may be transferred to the substrate 10.

Then, the control unit 600 may compare the pattern transferred to the substrate 10 and the desired (or alternatively, preset or target) pattern, and determines whether the pattern transfer has been successful or not.

At this time, because the functional material of the stamps coupled to the objective lens is totally transferred to the substrate, the determination as to whether the pattern transfer has been successful may be done using the objective lens used for the transfer or using the objective lens having no stamp.

Next, as shown in FIG. 10E, if the pattern transfer has been completed, the control unit 600 may control the forward-backward and left-right movement of the stage unit 300 to move the substrate 10 to a position from which the substrate 10 can be easily withdrawn.

Because the stamps may be, for example, a transparent material, the determination as to whether the substrate 10 is normal may be done through the background part, to which the functional material is not spread, after spreading the functional material onto the stamps.

Also, the defect position marking pattern may be transferred to the area around the defect position of the substrate 10.

In more detail, after the transfer unit moves to the second stage and the functional material has been spread onto the stamps, the stamps may move to the first stage and may determine as to whether the substrate has a defect. At this time, if it is determined that the substrate has a defect, the stamps may move down toward the defect position, and the defect position marking pattern may be transferred to the area around the defect position of the substrate.

Such a process may enable a user to analyze the cause of the substrate defect with relative ease.

As described above, the micro pattern transfer apparatus equipped with the optical microscope integrated with the stamp can check the position of the substrate and simultaneously transfer the same pattern as the pattern of the stamp to the substrate.

Although a few example embodiments of the present inventive concepts have been shown and described in this specification and figures, it would be appreciated by those skilled in the art that changes may be made to the illustrated and/or described example embodiments without departing from the principles and spirit of the inventive concepts, and the scope of which is defined in the claims and their equivalents.

What is claimed is:

1. A pattern transfer apparatus comprising:
a microscope including,
an ocular lens in a first housing,
an objective lens in a second housing, and
a body tube connecting the ocular lens and the objective lens to each other; and
a stamp coupled to an opening of the second housing, the stamp having a pattern to be transferred to a substrate.

2. The pattern transfer apparatus according to claim 1, wherein the stamp is removably coupled to the opening of the second housing or is attached to the opening of the second housing.

3. The pattern transfer apparatus according to claim 1, wherein the stamp is made of a transparent elastomer.

4. The pattern transfer apparatus according to claim 1, further comprising:
a moving assembly configured to move the microscope; and
a control unit including,
an image acquisition part configured to acquire an image of the substrate through the ocular lens and the objective lens, and
a controller configured to check at least one of a transfer position and a defect position based on the image of the substrate and configured to control an operation of the moving assembly such that the pattern is transferred to at least one of the transfer position and the defect position.

5. The pattern transfer apparatus according to claim 1, wherein
the objective lens and the second housing are provided in plural, respectively, and
the microscope further includes a rotary plate, the rotary plate is configured to change positions of the plurality of objective lenses.

6. The pattern transfer apparatus according to claim 5, wherein
the plurality of objective lenses have different magnifications from each other, and
the stamp having a micro pattern is coupled to the objective lens, the objective lens having a magnification sufficient to observe the micro pattern.

7. A control method for a pattern transfer apparatus including a first stage on which a substrate is located, a second stage onto which a functional material is spread, and a microscope moving between the first stage and the second stage, the control method comprising:
moving the microscope integrated with a stamp to the second stage;
controlling contact between the functional material and the stamp such that the functional material is spread onto a pattern of the stamp;
moving the microscope integrated with the stamp to the first stage after completing the spreading of the functional material onto the pattern of the stamp;
checking the substrate through the microscope integrated with the stamp;
controlling contact between the microscope integrated with the stamp and the substrate such that the pattern of the stamp is transferred to the substrate; and
moving the microscope integrated with the stamp away from the substrate after completing the transferring of the pattern to the substrate.

8. The control method according to claim 7, wherein the controlling contact between the microscope integrated with the stamp and the substrate includes controlling contact pressure of the microscope integrated with the stamp to apply a desired pressure to the substrate.

9. The control method according to claim 7, wherein the checking the substrate includes acquiring an image of the substrate through the microscope integrated with the stamp, and checking a defect position of the substrate based on the image.

10. The control method according to claim 9, wherein the transferring the pattern of the stamp to the substrate includes transferring a defect position marking pattern to an area around the defect position.

11. The control method according to claim 9, wherein the checking the substrate includes acquiring an image of the substrate through the microscope integrated with the stamp, checking a previously-formed pattern based on the image, and checking a transfer position of the substrate based on the previously-formed pattern.

12. The control method according to claim 11, further comprising:
selecting an objective lens of a plurality of objective lenses based on the previously-formed pattern, each of the plurality of objective lens having a stamp with the pattern to be transferred to the substrate; and
controlling rotation of a rotary plate to which the plurality of objective lenses are mounted such that the selected objective lens is positioned opposite the first stage.

13. The control method according to claim 7, further comprising:
determining whether the transferring of the pattern is successful by comparing the pattern transferred to the substrate and a target pattern.

14. The control method according to claim 7, further comprising:
selecting an objective lens of a plurality of objective lenses through an input part; and
controlling rotation of a rotary plate to which the plurality of objective lenses are mounted such that the selected objective lens is positioned opposite the first stage.

15. A pattern transfer apparatus comprising:
a first stage configured to support a substrate; and
a transfer unit including,
an ocular lens and at least one objective lens coupled to the ocular lens through a connection structure, the at least one objective lens configured to face the first stage, the ocular lens configured to magnify an image magnified by the objective lens, and
a stamp removably coupled to the objective lens, the stamp including a background part embossed or engraved with a pattern.

16. The pattern transfer apparatus of claim 15, wherein the stamp is made of a transparent elastomer such that the substrate is observable through the at least one objective lens.

17. The pattern transfer apparatus of claim 15, wherein the connection structure is a body tube, the body tube providing physical and/or mechanical connection between the ocular lens and the at least one objective lens and maintaining a distance therebetween.

18. The pattern transfer apparatus of claim 15, further comprising a rotary plate on which the at least one objective lens is rotatably mounted,
wherein the at least one objective lens is a plurality of objective lenses having different magnification levels,

19. The pattern transfer apparatus of claim 15, wherein the background part of the stamp includes,
a body,
an accommodating part enclosed by the body, the accommodating part configured to store a functional material, and
a discharge part covered by the pattern, the discharge part configured to discharge the functional material through the pattern.

20. The pattern transfer apparatus of claim 15, further including:
a dispenser adjacent to the transfer unit, the dispenser configured to discharge a functional material through outlet ports thereof; and
a second stage near the first stage, the second stage having a container configured to receive the functional material from the dispenser.
